(19) United States
(12) Patent Application Publication
(10) Pub. No.: US 2007/0124067 A1
(43) Pub. Date: May 31, 2007

(54) NAVIGATION SYSTEM HAVING PATH SEARCH FUNCTION BASED ON NUMBER OF INTERSECTIONS AND METHOD THEREOF

(76) Inventors: Sung Joong KIM, Icheon-si (KR); Jin Su Lim, Icheon-si (KR)

Correspondence Address: IPLA P.A., 3580 WILSHIRE BLVD., 17TH FLOOR, LOS ANGELES, CA, 90010, US

(21) Appl. No.: 11/559,383

(22) Filed: Nov. 13, 2006

(30) Foreign Application Priority Data
Nov. 29, 2005 (KR) 10-2005-0114945

(51) Int. Cl. G01C 21/32

(52) U.S. Cl. 701/209; 340/995.19

(57) ABSTRACT

Provided is a navigation system having a path search function based on number of intersections and a method thereof. The system includes a Global Positioning System (GPS) module for receiving each position signal, and calculating a self position; a map DataBase (DB) for storing map data including information on a road and an intersection of the road; a storage unit for storing at least two searched paths and number of intersections; and a controller for searching the map data for at least two possible paths from a current position to a destination, storing the searched paths in the storage unit, counting the number of intersections, selecting the path having the least counted number of intersections, and mapping the selected path to the map data.

### CROSS REFERENCE

Applicant claims foreign priority under Paris Convention and 35 U.S.C. § 119 to the Korean Patent Application No. 10-2005-0114945, filed Nov. 29, 2005 with the Korean Intellectual Property Office.

### BACKGROUND OF THE INVENTION

1. Field of the Invention

The present invention relates to a navigation system for searching a path, and more particularly, to a navigation system having a path search function based on the number of intersections and a method thereof, for searching at least two paths upon execution of path search, selecting the path having the least number of intersections among the searched paths, and performing path guide.

2. Description of the Related Art

In general, a navigation system including a Global Positioning System (GPS) module receives each position signal from a plurality of GPS satellites through the GPS module, and calculates a self position. Calculating the self position, the navigation system maps the calculated position to map data, and displays the mapped position. The navigation system receives a destination from a user, searches a path from the calculated current position to the destination, maps the searched path to the map data, and performs road guide along the searched path.

In general, path search methods are a method for searching a path by shortest distance, expressway priority, or national highway priority, and a method for searching a path by traffic information using a separate traffic information receiver.

The path search method based on the shortest distance, the expressway priority, or the national highway priority has a drawback that, since it does not consider a traffic congestion of the road, the user suffers an inconvenience caused by traffic stagnation while driving a car along the searched path.

Also, the path search method based on the traffic information has a drawback that, since the separate traffic information receiver should be additionally provided, a purchase cost is additionally incurred.

### SUMMARY OF THE INVENTION

Accordingly, the present invention is directed to a navigation system having a path search function based on the number of intersections and a method thereof that substantially overcome one or more of the limitations and disadvantages of the conventional art.

One object of the present invention is to provide a navigation system having a path search function based on the number of intersections and a method thereof, for searching at least two paths upon execution of path search, selecting the path having the least number of intersections among the searched paths, and performing path guide.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a navigation system having a path search function based on number of intersections. The system includes a Global Positioning System (GPS) module for receiving each position signal from a plurality of GPS satellites, and calculating a self position by the position signal; a map DataBase (DB) for storing map data including information on a road and an intersection of the road; a storage unit for storing at least two searched paths and number of intersections provided on a road of each path; and a controller for searching the map data for at least two possible paths from a current position to a destination inputted by a user upon execution of path search, storing the searched paths in the storage unit, counting the number of intersections provided on the road of each searched path, selecting the path having the least counted number of intersections, and mapping the selected path to the map data.

In another aspect of the present invention, there is provided a method for searching a path by number of intersections in a navigation system. The method includes determining whether a path search mode based on number of intersections is set upon execution of path search according to user's inputting of a destination; searching map data for at least two possible paths from a current position to the destination when the path search mode based on the number of intersections is set; counting the number of intersections provided on the road of each searched path; and selecting the path having the least counted number of intersections, mapping the selected path to the map data, and displaying the mapped path.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating a construction of a navigation system having a path search function based on the number of intersections according to the present invention; and

FIG. 2 is a flowchart illustrating a method for searching a path by the number of intersections in a navigation system according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention is to search at least two paths from a current position to a destination and select the path having the least number of intersections among the searched paths, thereby avoiding a traffic congestion caused by a traffic signal at the intersection, which is one of key causes of the traffic congestion, and guiding to the destination.

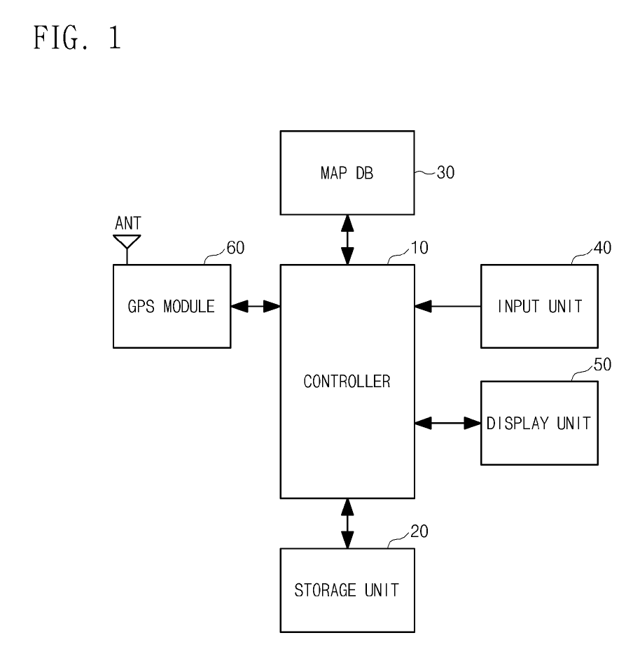

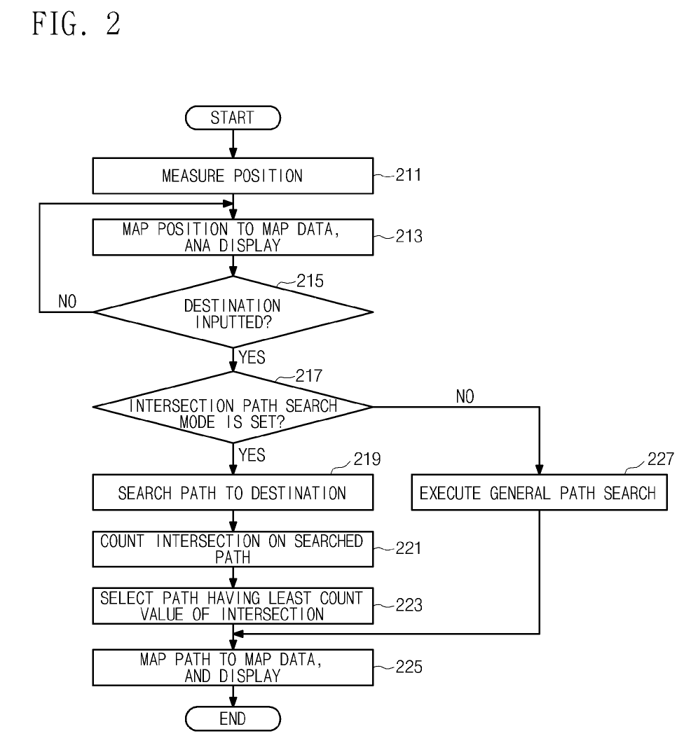

A construction of a navigation system having a path search function based on the number of intersections and a method for searching a path according to the present invention will be described with reference to FIGS. 1 and 2 below.

FIG. 1 is a block diagram illustrating a construction of the navigation system having the path search function based on the number of intersections according to the present invention.

Referring to FIG. 1, the navigation system includes a controller 10, a storage unit 20, a map DataBase (DB) 30, an input unit 40, a display unit 50, and a Global Positioning System (GPS) module 60.

The controller 10 controls a general operation of the navigation system according to the present invention.

The storage unit 20 includes a region for storing a control program for controlling the operation of the navigation system; a region for temporarily storing data generated in execution of the control program; and a region for storing information on the searched paths, and the number of intersections provided on the search path.

The map DB 30 stores map data having information on a nationwide topography, which is mapped on the basis of latitude and altitude, and a road on the topography, information on road name and lane, and information on a change point of the road. The change point refers to a point where the lane changes on an arbitrary road, and an intersection point.

The input unit 40 includes a plurality of keys or buttons for allowing a user to control the navigation system according to the present invention. The input unit 40 generates key data on the key or button pressed by the user among the keys or buttons, and outputs the generated key data to the controller 10.

Under the control of the controller 10, the display unit 50 displays an operation state and additional information of the navigation system, and displays the map data to which a self position and the searched path are mapped. The display unit 50 can also employ a touch screen.

The GPS module 60 includes a gyroscope (not shown) for sensing a progress direction, and a GPS receiver (not shown) for receiving each position signal from a plurality of GPS satellites through a GPS antenna (ANT) and calculating the current self position. The GPS module 60 outputs information on the sensed direction and information on the calculated current position, to the controller 10.

FIG. 2 is a flowchart illustrating a method for searching the path by the number of intersections in the navigation system according to the present invention. A description will be made with reference to FIGS. 1 and 2 below.

In Step 211, the controller 10 measures the current self position using the GPS module 60. After the measuring of the current self position, in Step 213, the controller 20 maps the measured current position to the map data of the map DB 30, and displays the mapped position on the display unit 50.

Displaying the map data to which the current position is mapped, the controller 10 determines whether the destination is inputted depending on destination setting in Step 215.

If the destination is inputted through the input unit 40 in the Step 215, the controller 10 determines whether an intersection path search mode is set in Step 217. The intersection path search mode is identical with a general path search mode. Among arranged path search modes, the intersection path search mode can be selected and set.

When it is determined that the intersection path search mode is not set in the Step 217, the controller 10 performs the path search in the general path search mode such as a shortest distance path search mode, an expressway priority path search mode, and a national-highway priority path search mode, and proceeds to Step 225.

When it is determined that the intersection path search mode is set in the Step 217, the controller 10 searches at least two paths from the current position to the destination in Step 219.

Searching at least two paths to the destination, in Step 221, the controller 10 counts the number of intersections on the road provided on each searched path, and stores the counted number of intersections in the storage unit 20.

Counting the number of intersections on each searched path, the controller 10 selects the path having the least counted number of intersections in Step 223, and maps the selected path to the map data and displays the mapped path on the display unit 50 in Step 225.

The above description is that only the number of intersections is counted, and the path having the least counted number of intersections is selected. However, the path can be selected on the basis of the number of crosswalks. In this case, the map DB 30 should include information on the crosswalk of the road.

As described above, the method for searching the path by the number of intersections according to the present invention has an advantage that the user can drive a car avoiding a traffic congestion area since he/she is guided along the path on which the intersections causing the traffic congestion are least in number.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A navigation system having a path search function based on number of intersections, the system comprising:
a Global Positioning System (GPS) module for receiving each position signal from a plurality of GPS satellites, and calculating a self position by the position signal;
a map DataBase (DB) for storing map data comprising information on a road and an intersection of the road;
a storage unit for storing at least two searched paths and number of intersections provided on a road of each path; and
a controller for searching the map data for at least two possible paths from a current position to a destination inputted by a user upon execution of path search, storing the searched paths in the storage unit, counting the number of intersections provided on the road of each searched path, selecting the path having the least counted number of intersections, and mapping the selected path to the map data.

2. A method for searching a path by number of intersections in a navigation system, the method comprising:
determining whether a path search mode based on number of intersections is set upon execution of path search according to user's inputting of a destination;
searching map data for at least two possible paths from a current position to the destination when the path search mode based on the number of intersections is set;
counting the number of intersections provided on the road of each searched path; and
selecting the path having the least counted number of intersections, mapping the selected path to the map data, and displaying the mapped path.
